(19) United States
(12) Patent Application Publication
(10) Pub. No.: US 2025/0355136 A1
(43) Pub. Date: Nov. 20, 2025

(54) NEURAL NETWORKS FOR TOPOLOGY OPTIMIZATION OF METASURFACES

(71) Applicant: CORNING INCORPORATED, CORNING, NY (US)

(72) Inventors: Jeremy Robert Hadler, Horseheads, NY (US); Jun Yang, Los Gatos, CA (US)

(21) Appl. No.: 18/871,518

(22) PCT Filed: Jun. 14, 2023
(86) PCT No.: PCT/US2023/025271

§ 371 Date: Dec. 4, 2024

Related U.S. Application Data
(60) Provisional application No. 63/355,671, filed on Jun. 27, 2022.

(51) Int. Cl. G02B 1/00; G06F 30/27; G06F 111/06

(52) U.S. Cl. CPC G02B 1/002; G06F 30/27; G06F 2111/06

(57) ABSTRACT

To create high-performance metasurface devices (110) in an inverse design process over a large design space (100), a deep neural network may be used as a surrogate model in lieu of a full physics simulation to more efficiently predict figures of merit for given input metasurface topologies during the iterative topology optimization. The neural network may also serve to efficiently compute, via backpropagation, gradients of the figures of merit with respect to design parameters, as are used to update the topology in each iteration.

### CROSS-REFERENCE TO RELATED APPLICATION

This application claims the benefit of priority under 35 U.S.C. § 119 of U.S. Provisional Application Ser. No. 63/355,671 filed on Jun. 27, 2022, the content of which is relied upon and incorporated herein by reference in its entirety.

### FIELD OF INVENTION

The present application is directed toward optical devices. More particularly, the present application is directed toward neural networks for topology optimization of metasurfaces.

### BACKGROUND

Metasurfaces have recently attracted much research interest in optical device design, as their unique sub-wavelength features make it possible to engineer very precisely the way light interacts with the surface. As a result, metasurfaces have been used to implement a wide range of optical devices, including a meta-lens, a compact spectrometer, an orbital angular momentum laser, and an ultrafast optical pulse shaper, to name just a few. The thin-film nature of metasurfaces, combined with a choice of high-index material, can achieve significant improvements in form factor, rendering metasurfaces particularly attractive for wearable or augmented-reality (AR) and/or virtual-reality (VR) applications. Furthermore, the large design space available to metasurfaces enables simultaneous engineering of multiple functionalities, resulting in devices and functions simply impossible with traditional bulk optics, such as a compact full-Stokes polarization camera, incident-angle-independent focusing, etc.

Traditional metasurface design is generally based on simple geometric shapes, which can be characterized with only a few parameters. Due to the thus limited size of the design library, the device efficiency, too, is often limited. As an alternative approach, inverse design, in particular with adjoint topology optimization, has been used to design metasurfaces with significantly greater freedom. Instead of restricting the design to certain shapes, such as multiple elliptical pillars or cuboids, inverse design renders the entire topology of the structure variable, leading to a significantly larger search space, and potentially better solutions. However, an inverse design optimization in its entirety often involves hundreds of iterations, each iteration requiring a full physics simulation of the full structure, which is time-consuming. Depending on the size of the device, it may take hours or even days to optimize one structure. Moreover, if the goal is to create an entire library of such structures, all with different targets, the process quickly becomes intractable.

### BRIEF DESCRIPTION OF THE DRAWINGS

Described herein is an approach to inverse design of metasurfaces that employs neural networks as surrogates for full physics simulations, rendering topology optimization over a large design space computationally tractable. Various embodiments and examples are described with reference to the accompanying drawings, in which:

FIG. 1 is a flowchart illustrating an example process of creating metasurface devices;

FIG. 2 is a conceptual diagram illustrating, at a high level, the use of a neural network model for metasurface topology optimization;

FIG. 3 is a flow diagram of an example inverse design process for metasurface topology optimization;

FIG. 4 is a schematic cross section of an example meta-grating as may be designed using the process of FIG. 3;

FIG. 5 is a two-dimensional scatter plot of scattering efficiencies within a training dataset used to create a neural network as used in the inverse design process of FIG. 3 to design the meta-grating of FIG. 4;

FIG. 6 shows an example metasurface topology of the training dataset used to create a neural network as used in the inverse design process of FIG. 3 to design the meta-grating of FIG. 4, along with similar versions of the metasurface topology used to augment the training dataset;

FIG. 7 is a schematic of an example architecture of a neural network as used in the inverse design process of FIG. 3 to design the meta-grating of FIG. 4;

FIGS. 8A and 8B are scatter plots of predicted vs. actual scattering efficiencies for the neural network of FIG. 7 as trained on the training dataset illustrate in FIG. 5.

FIG. 9 is a graph comparing gradients of the scattering efficiencies with respect to design parameters as computed with the neural network of FIG. 7 vs. as computed numerically.

FIG. 10 shows example metasurface topologies generated for the meta-grating of FIG. 4 using the process of FIG. 3 and neural network of FIG. 7.

FIG. 11 is a block diagram of an example computing machine on which inverse design methods may be executed.

### DESCRIPTION

This disclosure relates to methods for creating high-performance metasurface devices, and in particular computer-implemented metasurface design methods that integrate topology optimization with surrogate modeling using a deep neural network (DNN). The methods can find application, for instance, in the optimization of optical metasurfaces, which are thin-film optical components composed of subwavelength microstructures modulating the amplitude, phase, and/or polarization of light. The microstructures are generally defined by variations in the thickness of a thin layer of material (herein the “metasurface layer”) disposed on an underlying substrate. These thickness variations are often binary (meaning that the thickness varies between two discrete values, one of which may be zero), although metasurfaces with stepped microstructures involving three or more discrete thicknesses are also possible. The thickness variations define the “topology” of the metasurface, which metasurface design methods seek to optimize for certain optical device performance metrics, herein referred to as “figures of merit.”

In contrast to prior neural-network-based metasurface design methods, which often severely limit the design space, such as by constraining the surface topology to arrays of simple geometric shapes (e.g., pillars) with a limited number of free design parameters, the present approach allows essentially free-form designs of the shape of the metasurface layer. It represents the topology of the metasurface generically with a pixelated image (e.g., having 400 or more pixels), thereby covering a large range of possible topologies (limited only by the image resolution). The pixelated image serves as input to the DNN, which generates the corresponding figure(s) of merit as output. Once trained on known metasurface designs and corresponding figures of merit (e.g., as computed with a full numerical electromagnetic or similar physics simulations), the DNN can not only predict the performance of a metasurface device for any arbitrary pattern on the device with high accuracy, but also very efficiently calculate the sensitivity of the performance with respect to the design by backpropagation. Incorporating the trained DNN, as a surrogate model for a numerical physics simulation, into an iterative topology optimization can significantly reduce the computational time to achieve high-performance metasurface designs. In some examples, inverse topology optimization using a DNN in accordance with this disclosure is more than two orders of magnitude faster than conventional inverse topology optimization.

The preceding high-level summary will become clearer from the following description of various example embodiments with reference to the accompanying drawings.

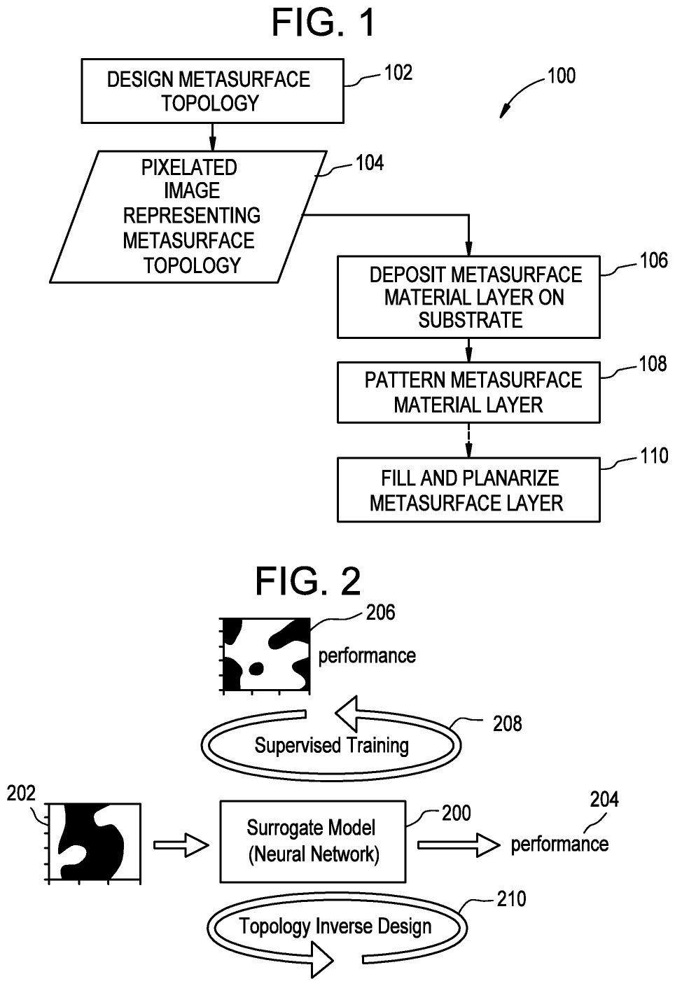

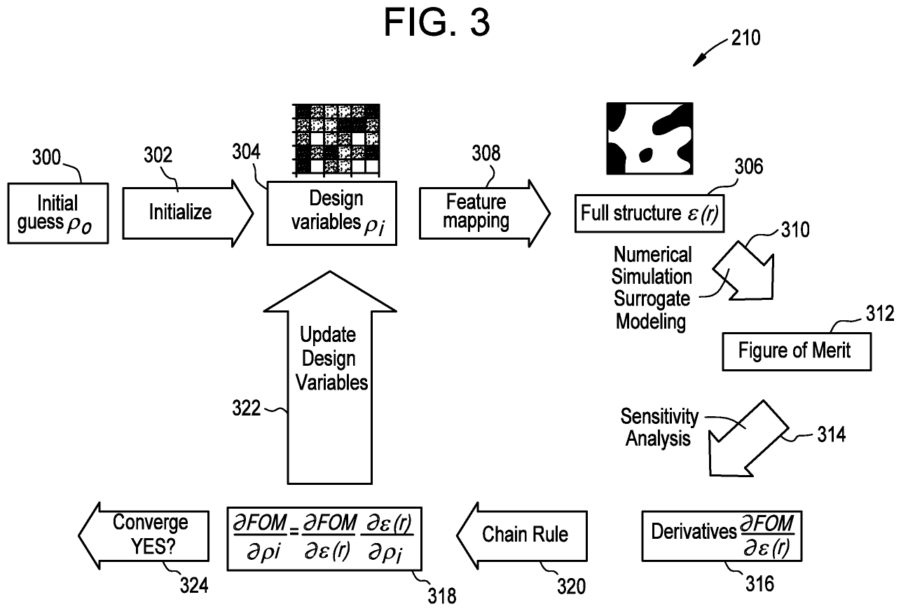

FIG. 1 is a flowchart illustrating an example process 100 of creating metasurface devices. The process 100 involves inversely designing a topology of the metasurface layer in a free-form design domain, e.g., as described in detail below with reference to FIG. 3 (act 102), resulting in a pixelated image 104 describing the topology.

The physical manufacture of the metasurface in accordance with the optimized design begins with the deposition of a generally thin layer, or film, of metasurface material on a substrate (act 106). Various deposition techniques suitable for this purpose are known in the art and include, without limitation, physical vapor deposition (PVD) techniques such as sputtering, thermal evaporation, or pulsed laser deposition, and chemical vapor deposition (CVD) techniques like plasma-enhance CVD, low-pressure CVD, or atomic-layer deposition. The resulting metasurface layer thicknesses may be in the range from about 100 nm to about 2 μm. The metasurface layer material may be a semiconductor, a dielectric (e.g., silicon nitride, gallium nitride, silicon oxide, titanium oxide, amorphous silicon, high-index glass, high-index polymer), or a metal. Materials that may be suitable for the substrate include, for example, glass, silicon, sapphire, and polymer. In general, the choice of materials and material properties of the metasurface layer and substrate may be informed by the type of device or end application. For example, for optical devices to be operated in transmission, the selected substrate will be transparent to light in the operating wavelength band, whereas substrates for reflective devices may (but need not necessarily be) opaque. Metasurface layer materials may be selected based on, among other things, their refractive index and absorption coefficients. For example, amorphous silicon is a good material choice for near-infrared telecommunication applications due to its high refractive index, but a poor choice for applications in the visible regime due to its high absorption.

The deposited layer of metasurface material is patterned, in act 108, in accordance with the surface topology design as represented by the pixelated image 104. Various microlithography techniques suitable for this purpose are known in the art. For example and without limitation, a layer of photoresist may be deposited on top of the metasurface layer and photolithographically patterned to create an etch mask covering what will become the raised structures in the metasurface, and the mask pattern may then be transferred to the metasurface layer by etching away the exposed portions of the layer. The etch mask itself is subsequently removed. Optionally, a cladding material of sufficiently different properties than the metasurface material (e.g., providing a high refractive-index contrast) may be applied to fill the recesses in the resulting metasurface layer, and the layer may be planarized (act 110). In many cases, however, air may serve as the cladding, leaving a rough metasurface.

Although in the example process 100, patterning follows the deposition of a uniform layer of metasurface material on a substrate, the reverse order of steps is also possible. For instance, in a lift-off patterning process, a sacrificial material layer is deposited on the substrate and patterned in accordance with the negative of the pixelated image, exposing regions of the substrate where the raised structures will be. The metasurface material is then deposited over the sacrificial material and substrate, and the sacrificial material is thereafter washed out, along with any metasurface material that was deposited on top, leaving the final patterned metasurface layer.

Metasurface devices are often planar devices formed by the metasurface layer and an underlying flat substrate of uniform thickness. For example, meta-lenses are usually planar components patterned to achieve the refractive properties of a conventional bulk-optical lens without the need for a curved surface. However, it is also possible to apply metasurfaces to nonplanar or bulk components. For example, a refractive optic may be created from a wedge-shaped substrate that itself constitutes a bulk-optical component, augmented by a metasurface layer deposited on one or both sides of the wedge. In principle, it is also possible to create curved metasurface devices, either by forming a metasurface layer directly on top of a curved surface of the device, or by forming the metasurface layer on a planar, but flexible substrate and then conforming the substrate to the curved surface.

Turning now to the design of metasurface topologies (act 102), FIG. 2 is a conceptual diagram illustrating, at a high level, the use of a neural network model 200 for metasurface topology optimization. The neural network 200 is used as a surrogate model to replace the computationally costly numerical simulation conventionally used in inverse topology design. The neural network 200 may be a DNN, meaning a network with multiple layers of artificial neurons between the input and output layers (e.g., between a vector input representing the pixelated image and a scalar or vector output quantifying one or more figures of merit). The specific architecture of the DNN may be defined, or selected among known neural network architectures, by those of ordinary skill in the art, e.g., based on observed neural network performance or a priori based on the task at hand (e.g., the type of metasurface device to be designed or the figures of merit), but in general, any multi-layer network architecture may be used. For example, the DNN may be fully connected, or may be a deep convolutional network (DCN), optionally including layers configured as a residual neural network (ResNet).

The neural network 200 takes a pixelated image 202 representing the metasurface topology of a metasurface device as input and produces one or more figures of merit characterizing the resulting performance 204 of the device as output. Relevant figures of merit generally depend on the type of metasurface device. For example, figures of merit that may be of interest in characterizing the performance of optical meta-gratings include a scattering efficiency, scattered power, or similar scattering metric, e.g., associated with a specific grating order, polarization, and/or wavelength or wavelength range, or an overall transmission or reflection efficiency. For a meta-lens, the figures of merit may be or include a focusing efficiency or intensity at the focus. Figures of merit for polarization-discriminating devices may include a phase difference or scattering efficiency difference between two orthogonal polarizations, while figures of merit for wavelength-discriminating devices may include a phase difference between two specified wavelengths or a phase gradient with respect to wavelength. Additional figures of merit will occur to those of ordinary skill in the art.

The neural network 200 is trained on a large, diverse training dataset 206 including data for metasurface devices with both high and low values of the figure(s) of merit (e.g., high and low scattering efficiencies). The data includes, for each of the devices in the training dataset, the pixelated image describing the metasurface topology of the device, paired with the value(s) of the figure(s) of merit. The figures of merit are calculated from the pixelated images using rigorous physics (e.g., electromagnetic) simulations. Such simulations can be performed, for instance, using commercially available electromagnetic field simulation tools that implement algorithms such as a finite-difference time domain (FDTD), finite-difference frequency domain (FDFD), finite element (FE), or rigorous coupled-wave analysis (RCWA) algorithms, among others. In some example, the training dataset is augmented with modified versions of pixelated images from the original dataset and associated figures of merit. Using certain heuristics, such augmentation can increase the variety of the training data without incurring the cost of having to simulate the added topologies. For instance, using symmetry considerations, such as the invariance of a certain figure of merit to a translation or mirror image of the pixelated image, mirrored and shifted images can be added to the training data, paired with the figures of merit of the original images.

The training dataset is used in supervised training 208 to train the neural network 202. In general, the training involves iteratively adjusting free parameters of the neural network 202, such as the weights associated with the nodes in each neural network layer, to minimize an error function (also often referred to as a cost function) that measures, conceptually speaking, the difference between the value(s) of the figure(s) of merit output by the neural network 202 for a given pixelated image input and the corresponding simulated value(s) provided as part of the training data pair. Neural networks can be trained by backpropagation of errors using gradient descent, a learning algorithm well-known to those of ordinary skill in the art. In this iterative method, the gradient of the error with respect to the weights of the network is calculated, proceeding backward through the network, to determine adjustments to the weight during each training iteration. The training process ends when the error converges and/or falls below a specified threshold, corresponding to a desired accuracy of the predictions made by the neural network.

After the training, then neural network 200 is able to predict the performance of any arbitrary new metasurface topology that it has not seen before with high accuracy. This capability is used during iterative topology optimization 210 to design new metasurface devices based on certain requirements on the figures of merit, an approach generally referred to as “inverse design.”

FIG. 3 is a flow diagram of an example inverse design process for metasurface topology optimization (210). The process starts with a set of initial design variables ρ₀ (300) (e.g., in many cases, random numbers), which are used to initialize (at 302) the current design variables ρᵢ (304) that are to be optimized in an iterative process (where ρ denotes an array of multiple scalar design variables, and i is the iteration index). The design variables ρᵢ (304) correspond to a pixelated image of lower spatial resolution, but greater bit depth than the pixelated image ϵ(r) (306) representing the topology of the actual metasurface. (In the pixelated image ϵ(r), r denotes a two-component vector specifying the pixel coordinates (x, y) within the image, and ϵ is dielectric constant of the material at those coordinates, and is binary, e.g., ϵ_{low} Or ϵ_{high} The spatial resolution specifies the number of pixels per row and column across the image area, which covers the extent of the metasurface under design. The bit depth specifies the binary logarithm of the number of (color or gray-scale) values each pixel can take. In the case of a binary metasurface design, the bit depth of the pixelated image ϵ(r) (306) is 1, corresponding to 2¹ values. The bit depth of the design variables ρᵢ (304) may be much greater, e.g., in the range from 8 to 16 (corresponding to between 256 values and over 65000 color or gray-scale values) On the other hand, the number of design variables ρᵢ is generally much smaller, e.g., on the order of tens or hundreds, than the number of pixels in the image ϵ(r), which may be in the range from hundreds to hundreds of thousands.

In general, the number of pixels in the image ϵ(r) depends on the lateral dimensions of the metasurface and on the spatial resolution of each pixel, which in turn depends on the operating wavelength range. For example, the pixel size may be chosen to be less than 1/20 of the wavelength within the metasurface material, to achieve the desired optical function; for a wavelength in vacuum of 1.55 μm and a refractive index in the metasurface material of 3.5, this puts an upper limit of about 22 nm on the pixel size. The spatial resolution of the design variables ρᵢ may correspond to the critical dimensions of the microstructures that make up the metasurface, e.g., the diameter of a pillar microstructure. This critical dimension may be limited by the fabrication method. For example, in e-beam lithography, a minimal feature size of 100 nm may be enforced, and thus the spatial resolution of ρᵢ will be ˜100 nm. This sets the spatial frequency of the design pattern to be no higher than the fabrication limitation. As will be appreciated, to accurately describe, for instance, a circular pillar, the spatial resolution of the image representing the actual structure needs to be much better than the dimension of the pillar.

The design variables ρᵢ (304) are mapped onto the pixelated image ϵ(r) (306) that fully describes the actual metasurface topology in a feature mapping process (308) that involves a number of image processing functions, such as image upscaling, filtering, and thresholding. Image upscaling turns a low-resolution image of ρᵢ into a high-resolution image, with the same resolution as ϵ(r). Image filtering may serve, for instance, to smoothen the edges of the microstructures, e.g., using a convolution of the design variables ρᵢ and a suitable filter kernel. Example kernels for smoothening edges include cone, Gaussian, and disk kernels:

$${h}_{cone} = max \{ R - \sqrt{{x}^{2} + {y}^{2}} , 0 \} \\ {h}_{gauss} = exp ( - ( {x}^{2} + {y}^{2} ) / 2 {σ}^{2} ) \\ {h}_{disk} = UnitStep ( R - \sqrt{{x}^{2} + {y}^{2}} )$$

Following filtering, the thresholding function may convert the high-bit-depth image into a lower-bit-depth, e.g., binary image.

Given the full description of the physical structure (i.e., in this case the topology) of the metasurface by means of the pixelated image ϵ(r) (306), surrogate modeling (310) with the trained neural network 200 (e.g., a DNN) is used in place of a numerical simulation to predict the performance of the device as characterized in one or more figures of merit (FOM) (312). Sensitivity analysis (314) then serves to calculate the derivative(s) of the FOM(s) with respect to the device topology,

$$\frac{\partial FOM}{\partial ϵ ( r )} ( 316 ) .$$

Instead of adjoint analysis, as is conventionally used when the metasurface device is simulated numerically, the neural network 200 allows obtaining the derivatives very efficiently by backpropagation through the network 200. The time it takes for the sensitivity analysis (316) is independent of the number of design variables ρᵢ, and only depends on the physical structure, ϵ(r), of the metasurface device. From the derivatives with respect to the device topology,

$$\frac{\partial FOM}{\partial ϵ ( r )} ( 316 ) ,$$

the derivatives with respect to the design variables,

$$\frac{\partial FOM}{\partial {ρ}_{i}} ( 318 ) ,$$

can be calculated using the chain rule:

$$\frac{\partial FOM}{\partial {ρ}_{i}} = \frac{\partial FOM}{\partial ϵ ( r )} \frac{\partial ϵ ( r )}{\partial {ρ}_{i}} .$$

These derivatives (318) are then used to update (at 322) the design variables (304) in a direction such that the updated design variables correspond to a metasurface device with higher performance. (While it is also possible, in principle, to directly optimize ϵ(r) based on

$$\frac{\partial FOM}{\partial ϵ ( r )} ,$$

the resulting solutions may include features too small to be reliably manufacturable; this problem is addressed by the optimization of design variables that are then mapped onto a pixelated image ϵ(r).) The process iterates until the topology design converges (at 324), meaning that the derivatives are small (e.g., as compared to a specified convergence threshold) such that the figure(s) of merit no longer change appreciably.

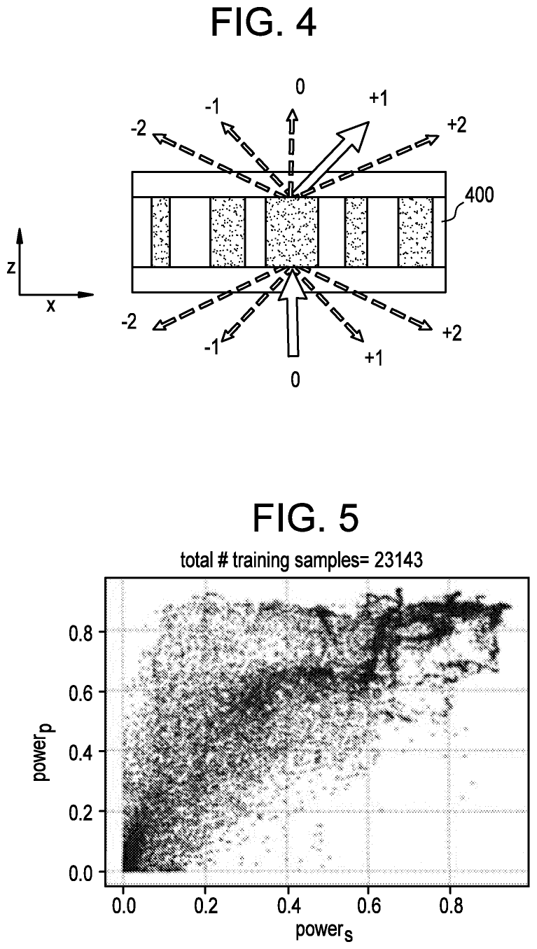

FIGS. 4-10 illustrate the metasurface topology optimization method 210 with the example of its application to the inverse design of a meta-grating. The objective is to design a 1.6 μm×0.5 μm meta-grating, made out of amorphous silicon (a-Si) as the metasurface material, with air as cladding. Error! Reference source not found. FIG. 4 shows the x-z cross section of the device, where x is in the plane of the metasurface and z is normal to the metasurface. The depicted middle layer 400 is the metasurface layer for which a two-dimensional pattern (in the x-y plane) is to be designed. For purposes of simplifying the computational design optimization, both top and bottom layers are assumed to be air, as are the spaces in the metasurface layer where the metasurface material has been removed. (In an actual physical implementation, the metasurface will be disposed on some type of substrate, such as, e.g., fused silica.) The goal is to scatter the normal incident light (0^{th} order) to the first diffraction (+1 order) in transmission (thick darker blue arrows) by minimizing both reflection and scattering into other orders. Such a device can be fabricated using thin-film deposition and lithography tools.

A good neural network model for predicting metasurface device performance depends on a training dataset that spans a large range of potential metasurface topologies, in other words, a large portion of the potential search space. In the illustrated example, the dataset was acquired using Rigorous Coupled-Wave Analysis (RCWA) to model about 30,000 different metasurface topologies. Each data point in the dataset consisted of a gray-scale image of 128×40 pixels representing the metasurface topology in the x-y plane, along with two figures of merit, powerₛ and powerₚ, corresponding to the scattering efficiencies from the 0^{th} order to the 1^{st} order for s-polarized light and p-polarized light, respectively. The data was divided into three sets: a training set (˜23,000 data points), a validation set (used for developing the model itself), and a test set (for final evaluation of the model). FIG. 5 is a two-dimensional scatter plot of the efficiencies computed for this training set. As can be seen, the training set covers metasurface performances ranging from zero to well over 90% efficiencies.

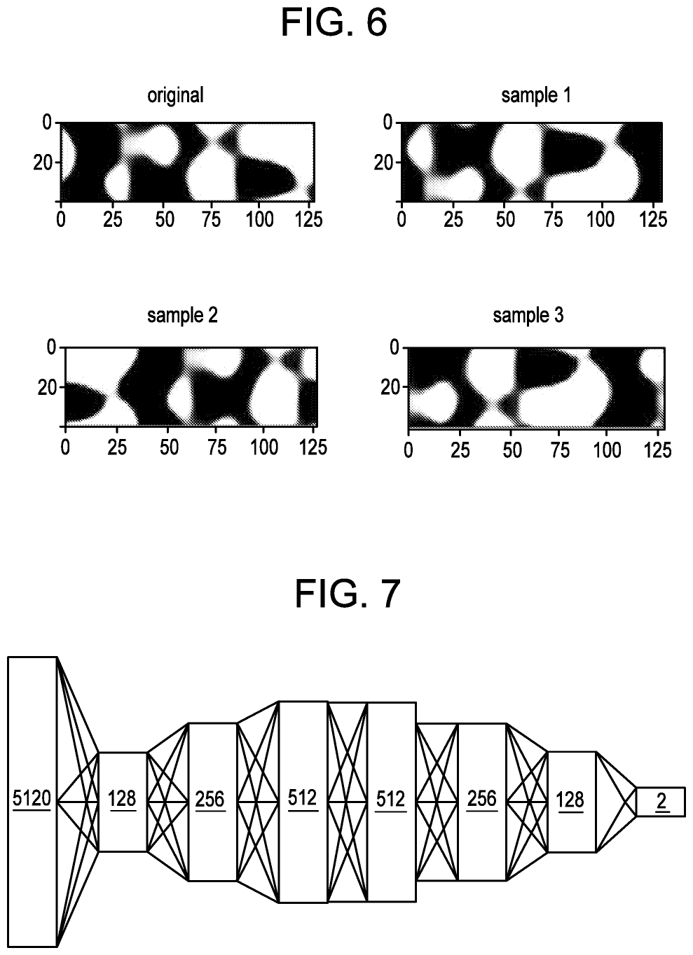

To further increase the variety of the training data, the training dataset was augmented with similar versions of existing topology designs. Randomly laterally shifted versions of the original pixelated images, paired with the scattering efficiencies of those original images, were added to the dataset, taking advantage of the periodic nature of the grating, which implies that a shift of the grating in-plane (x and y) should not change the scattering efficiency. Additionally, mirror versions of the original pixelated images, again paired with the scattering efficiencies of those original images, were added on the ground that, since the figures of merit measure scattering to the +1 order in the x direction, they should not be affected by a mirror image in the y direction. FIG. 6 provides an example of such data augmentation, showing an example of an original image (top left) along with a shifted version (bottom left) and two shifted mirror images (top and bottom right).

FIG. 7 schematically illustrates the general architecture of an example DNN as was used to design the meta-grating of FIG. 4. This specific DNN is fully connected, meaning that each node in each layer is connected to each node in the immediately following layer. The input layer of the DNN is a one-dimensional array of dimensions (5120,1) corresponding to the pixels of the pixelated image ϵ(r), and the output layer has two nodes representing the scattering efficiencies for s-polarization (TE) and p-polarization (TM), resulting in output dimensions (2,1). The DNN has six hidden layers with 128, 256, 512, 512, 256, and 128 nodes, respectively. In total, the DNN has about 1.25 million parameters. All internal layers have rectified linear units (relu) as the activation function. The last layer has a sigmoid activation function so that the output is always mapped to a number in the range (0,1). The DNN was fitted to the training data of FIG. 5, using L1 regularization to avoid overfitting, with Adamex as the optimizer.

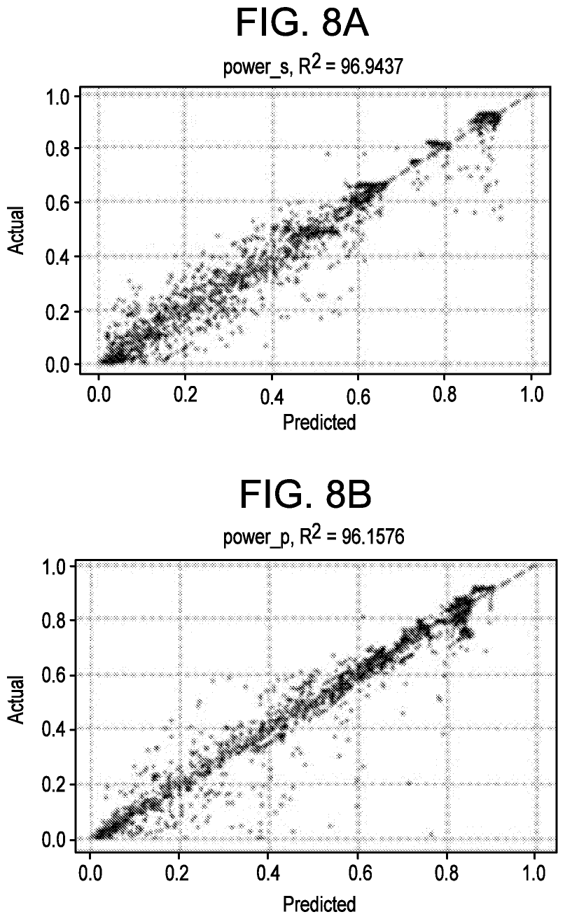

To illustrate the predictive performance of the DNN of FIG. 7 as trained on the training dataset illustrated in FIG. 5, FIGS. 8A and 8B show scatter plots of the predicted scattering efficiency vs. the actual (numerically simulated) efficiency (corresponding to the ground truth in the training data) for both s and p polarizations. The coefficient of determination (denoted R²), a statistic summarizing the amount of variability in the response that is explained by the model, has a value of about 0.96. The average error is around 5%. Once the DNN model is trained, it can very efficiently calculate the output efficiency for an arbitrary input design. The DNN achieved an estimated ˜200-times speed-up in evaluating a new design.

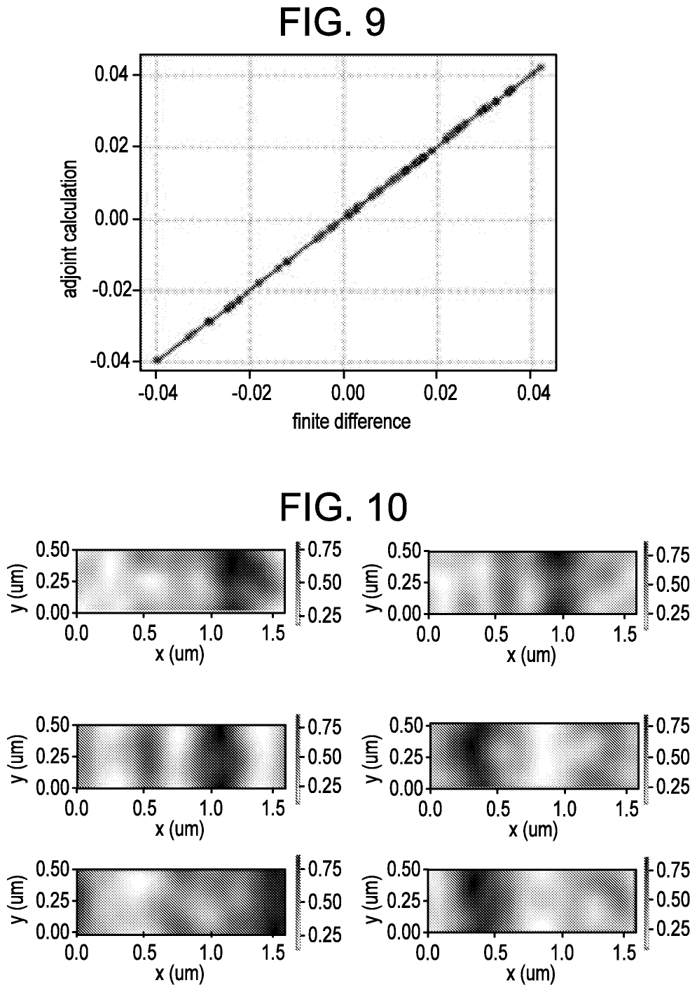

The trained DNN (of FIG. 7, having the predictive performance illustrated in FIGS. 8A and 8B) was used in an inverse design process of FIG. 3. The interface tf.GradientTape of Tensorflow was used to calculate the derivative of the model output (powerₛ and powerₚ) with respect to the model inputs (5120 design pixel values). This interface records values in the intermediate stages during the forward propagation, and then uses the stored values to calculate the derivatives through back-propagation, rendering the computation very efficient. Additional derivatives related to image pre-processing (that is, the mapping between the design variables and the pixelated image) were calculated according to the chain rule. For comparison between the neural-network-based gradient computation and conventional numerical gradient computation, FIG. 9 plots the gradients calculated with brute-force finite difference approximation vs. gradients calculated using autodiff realized through tf.GradientTape in Tensorflow, showing good agreement between the two. However, using autodiff to compute the gradients is much more computationally efficient.

Given the efficient gradient calculation, a limited-memory Broyden-Fletcher-Goldfarb-Shanno (LM-BFGS) algorithm in a SciPy implementation was used to iteratively search for the optimum design of the meta-grating, starting from a random initial topology. FIG. 10 shows example results that the optimizer generated after fifty iterations in six independent runs of the optimizer. One can see that the generated topologies show a large diversity, indicating that the optimizer is able to search over a large design space.

The disclosed methods for Inverse metasurface topology design using neural networks as described herein can generally be implemented in software stored and executed on general-purpose computing hardware (e.g., one or more central processing units (CPUs) accessing associated memory), with special-purpose hardware (e.g., a graphic processing unit (GPU), field-programmable gate array (FPGA), or application-specific integrated circuit (ASIC)), or using a combination of both. For example, software implementing the general iterative optimization loop may interface with a hardware accelerator implementing the neural network for predicting the figures of merit for a given metasurface topology.

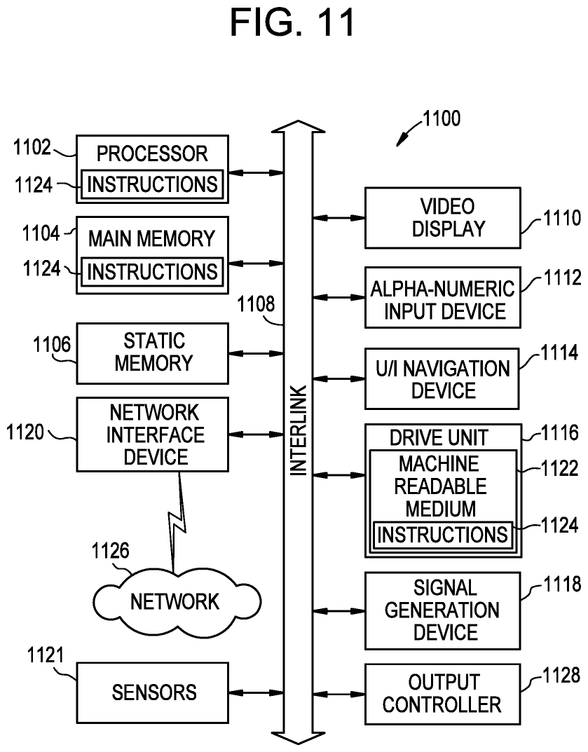

FIG. 11 is a block diagram of an example machine 1100 upon which any one or more of the techniques discussed herein may perform. In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet PC, a set-top box (STB), a personal digital assistant (PDA), a mobile telephone, a smartphone, a web appliance, a network router, switch or bridge, a server computer, a database, conference room equipment, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. In various embodiments, machine(s) 1100 may perform one or more of the processes described above with respect to FIGS. 2 and 3 above.

Machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1116, a signal generation device 1118 (e.g., a speaker), a network interface device 1120, and one or more sensors 1121. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1116 may include a machine-readable medium 1122 on which are stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine-readable media. While the machine-readable medium 1122 is illustrated as a single medium, the term “machine-readable medium” may include a single medium or multiple media (e.g., a centralized or distributed database, and/or associated caches and servers) configured to store the one or more instructions 1124.

The term “machine-readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Machine-readable media may include computer storage media, such as solid-state memories, optical or magnetic media, or other hardware storage devices, whether volatile or no-volatile, removable or non-removable, that store computer-readable instructions, data structures, program modules, or the like in tangible form. Machine-readable media may also include, in contrast, transmission media that embody computer-readable instructions, data structures, program modules, or the like in a modulated data signal, such as a carrier wave, or other transport mechanism. As defined herein, computer storage media do not include communication media; therefore, a computer storage medium should not be interpreted to be a transitory propagating signal per se. Specific examples of computer storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks.

The instructions 1124 may further be transmitted or received over a communications network 1126 using a transmission medium via the network interface device 1120. The machine 1100 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MIMO), or multiple-input single-output (MISO) techniques. In some examples, the network interface device 1120 may wirelessly communicate using Multiple User MIMO techniques.

Examples, as described herein, may include, or may operate on, logic or a number of components, modules, or mechanisms (all referred to hereinafter as “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Examples of the disclosed subject matter include the following:

1. A method of manufacturing an optical device with a metasurface layer designed to optimize one or more figures of merit. The method involves inversely designing a topology of the metasurface layer in a free-form design domain using a deep neural network trained on training data that includes pairs of pixelated images representing metasurface layer topologies and figures of merit computed based on the pixelated images by numerical electromagnetic simulation. The inverse design involves iteratively operating the deep neural network on a pixelated image representing the topology of the metasurface layer to compute the one or more figures of merit, operating the deep neural network backwards to calculate derivatives of the figure(s) of merit with respect to pixel values of the pixelated image representing the topology, and updating the pixelated image representing the topology based on the derivatives. A thin film can then be deposited on a substrate of the optical device, and the thin film can be patterned according to the updated pixelated image to manufacture the optical device optimized for the figure(s) of merit.

2. The method of example 1, wherein the pixelated image is created from a set of design variables, and wherein updating the pixelated image based on the derivatives includes: computing, from the derivative of the one or more figures of merit with respect to the pixel values of the pixelated image, derivatives of the one or more figures of merit with respect to the design variables; updating the design variables based on the derivatives of the one or more figures of merit with respect to the design variables; and creating an updated pixelated image from the pixelated design variables.

3. The method of example 2, wherein the design variables include an array of values having a lower spatial resolution and a higher bit depth than the pixelated image, and wherein creating the pixelated image from the design variables comprises image filtering and thresholding.

4. The method of any of examples 1-3, further comprising, prior to creating and iteratively updating the pixelated image, randomly initializing the set of design variables.

5. The method of any of examples 1-4, wherein the pixelated image has binary pixel values.

6. The method of any of examples 1-5, wherein the training data further comprises pairs of pixelated images and figures of merit computed from shifted or mirrored versions of the pixelated images by electromagnetic simulation.

7. The method of any of examples 1-6, wherein the one or more figures of merit include at least one scattering metric selected from a scattering efficiency or a scattered power.

8. The method of any of examples 1-7, wherein the one or more figures of merit include a scattering efficiency and the training data covers a range of the scattering efficiency from 0 to at least 80%.

9. The method of any of examples 1-8, wherein the optical device is a meta-grating, and the one or more figures of merit include a scattering metric associated with a specific grating order, a scattering metric associated with a specific polarization, a scattering metric associated with a specific wavelength or range of wavelengths, a transmission efficiency, and/or a reflection efficiency.

10. The method of any of examples 1-8, wherein the optical device is a polarization-discriminating device, and the one or more figures of merit include a phase difference and/or a scattering efficiency difference at a particular angle between two orthogonal polarizations.

11. The method of any or examples 1-8, wherein the optical device is a meta-lens, and the one or more figures of merit comprise a light intensity at a focus and/or a focusing efficiency.

12. The method of any of examples 1-8, wherein the optical device is a wavelength-discriminating device, and the one or more figures of merit comprise a phase difference between two specified wavelengths, a phase gradient with respect to wavelength, and/or scattering efficiencies for different wavelengths.

13. The method of any of examples 1-12, wherein the optical device is a augmented-reality or virtual-reality device.

14. One or more non-transitory computer-readable media storing instructions which, when executed by one or more computer processors, cause the processor to iteratively perform operations for designing a metasurface layer of an optical device to optimize one or more figures of merit. The operations include: operating a deep neural network on a pixelated image representing the topology of the metasurface layer to compute the one or more figures of merit, the deep neural network having been trained on training data comprising pairs of pixelated images and figures of merit computed based on the pixelated images by numerical electromagnetic simulation; operating the deep neural network backwards to calculate derivatives of the one or more figures of merit with respect to pixel values of the pixelated image representing the topology; and updating the pixelated image representing the topology based on the derivatives.

15. The one or more non-transitory computer-readable media of example 14, wherein the pixelated image is created from a set of design variables, and wherein updating the pixelated image based on the derivatives includes: computing, from the derivative of the one or more figures of merit with respect to the pixel values of the pixelated image, derivatives of the one or more figures of merit with respect to the design variables; updating the design variables based on the derivatives of the one or more figures of merit with respect to the design variables; and creating an updated pixelated image from the pixelated design variables.

16. The one or more non-transitory computer-readable media of example 14 or example 15, wherein the design variables include an array of values having a lower spatial resolution and a higher bit depth than the pixelated image, and wherein creating the pixelated image from the design variables comprises image filtering and thresholding.

17. The one or more non-transitory computer-readable media of any of example 14-16, wherein the training data further comprises pairs of pixelated images and figures of merit computed from shifted or mirrored versions of the pixelated images by electromagnetic simulation.

18. The one or more non-transitory computer-readable media of any of examples 14-17, wherein the one or more figures of merit comprise at least one scattering metric selected from a scattering efficiency or a scattered power.

19. The one or more non-transitory computer-readable media of any of examples 14-18, wherein the one or more figures of merit comprise a scattering efficiency and the training data covers a range of the scattering efficiency from 0 to at least 80%.

20. A system for designing a metasurface layer of an optical device to optimize one or more figures of merit. The system includes one or more computer processors and one or more computer-readable media storing instructions which, when executed by the one or more computer processors, cause the one or more computer processors to iteratively perform the following operations: operating a deep neural network on the pixelated image representing the topology of the metasurface layer to compute the one or more figures of merit, the deep neural network having been trained on training data comprising pairs of pixelated images and figures of merit computed based on the pixelated images by numerical electromagnetic simulation; calculating a derivative of the one or more figures of merit with respect to pixel values of the pixelated image representing the topology; and updating the pixelated image representing the topology based on the derivative.

21. A method of designing a metasurface layer of an optical device to optimize one or more figures of merit by performing the computational operations of any of examples 1-20.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of manufacturing an optical device with a metasurface layer designed to optimize one or more figures of merit, the method comprising:
inversely designing a topology of the metasurface layer in a free-form design domain by iteratively:
operating a deep neural network on a pixelated image representing the topology of the metasurface layer to compute the one or more figures of merit, the deep neural network having been trained on training data comprising pairs of pixelated images and figures of merit computed based on the pixelated images by numerical electromagnetic simulation;
operating the deep neural network backwards to calculate derivatives of the one or more figures of merit with respect to pixel values of the pixelated image representing the topology; and
updating the pixelated image representing the topology based on the derivatives;
depositing a thin film on a substrate of the optical device and patterning the thin film according to the updated pixelated image.

2. The method of claim 1, wherein the pixelated image is created from a set of design variables, and wherein updating the pixelated image based on the derivatives comprises:
computing, from the derivative of the one or more figures of merit with respect to the pixel values of the pixelated image, derivatives of the one or more figures of merit with respect to the design variables;
updating the design variables based on the derivatives of the one or more figures of merit with respect to the design variables; and
creating an updated pixelated image from the pixelated design variables.

3. The method of claim 2, wherein the design variables comprise an array of values having a lower spatial resolution and a higher bit depth than the pixelated image, and wherein creating the pixelated image from the design variables comprises image filtering and thresholding.

4. The method of claim 1, further comprising, prior to creating and iteratively updating the pixelated image, randomly initializing the set of design variables.

5. The method of claim 1, wherein the pixelated image has binary pixel values.

6. The method of claim 1, wherein the training data further comprises pairs of pixelated images and figures of merit computed from shifted or mirrored versions of the pixelated images by electromagnetic simulation.

7. The method of claim 1, wherein the one or more figures of merit comprise at least one scattering metric selected from a scattering efficiency or a scattered power.

8. The method of claim 1, wherein the one or more figures of merit comprise a scattering efficiency and the training data covers a range of the scattering efficiency from 0 to at least 80%.

9. The method of claim 1, wherein the optical device is a meta-grating, and the one or more figures of merit comprise at least one of a scattering metric associated with a specific grating order, a scattering metric associated with a specific polarization, a scattering metric associated with a specific wavelength or range of wavelengths, a transmission efficiency, or a reflection efficiency.

10. The method of claim 1, wherein the optical device is a polarization-discriminating device, and the one or more figures of merit include a phase difference or scattering efficiency difference at a particular angle between two orthogonal polarizations.

11. The method of claim 1, wherein the optical device is a meta-lens, and the one or more figures of merit comprise a light intensity at a focus or a focusing efficiency.

12. The method of claim 1, wherein the optical device is a wavelength-discriminating device, and the one or more figures of merit comprise a phase difference between two specified wavelengths, a phase gradient with respect to wavelength, or scattering efficiencies for different wavelengths.

13. The method of claim 1, wherein the optical device is a augmented-reality or virtual-reality device.

14. One or more non-transitory computer-readable media storing instructions which, when executed by one or more computer processors, cause the processor to perform operations for designing a metasurface layer of an optical device to optimize one or more figures of merit, the operations comprising iteratively:
operating a deep neural network on a pixelated image representing the topology of the metasurface layer to compute the one or more figures of merit, the deep neural network having been trained on training data comprising pairs of pixelated images and figures of merit computed based on the pixelated images by numerical electromagnetic simulation;
operating the deep neural network backwards to calculate derivatives of the one or more figures of merit with respect to pixel values of the pixelated image representing the topology; and
updating the pixelated image representing the topology based on the derivatives.

15. The one or more non-transitory computer-readable media of claim 14, wherein the pixelated image is created from a set of design variables, and wherein updating the pixelated image based on the derivatives comprises:
computing, from the derivative of the one or more figures of merit with respect to the pixel values of the pixelated image, derivatives of the one or more figures of merit with respect to the design variables;
updating the design variables based on the derivatives of the one or more figures of merit with respect to the design variables; and
creating an updated pixelated image from the pixelated design variables.

16. The one or more non-transitory computer-readable media of claim 14, wherein the design variables comprise an array of values having a lower spatial resolution and a higher bit depth than the pixelated image, and wherein creating the pixelated image from the design variables comprises image filtering and thresholding.

17. The one or more non-transitory computer-readable media of claim 14, wherein the training data further comprises pairs of pixelated images and figures of merit computed from shifted or mirrored versions of the pixelated images by electromagnetic simulation.

18. The one or more non-transitory computer-readable media of claim 14, wherein the one or more figures of merit comprise at least one scattering metric selected from a scattering efficiency or a scattered power.

19. The one or more non-transitory computer-readable media of claim 14, wherein the one or more figures of merit comprise a scattering efficiency and the training data covers a range of the scattering efficiency from 0 to at least 80%.

20. A system for designing a metasurface layer of an optical device to optimize one or more figures of merit, the system comprising:
one or more computer processors; and
one or more computer-readable media storing instructions which, when executed by the one or more computer processors, cause the one or more computer processors to iteratively perform operations comprising:
operating a deep neural network on the pixelated image representing the topology of the metasurface layer to compute the one or more figures of merit, the deep neural network having been trained on training data comprising pairs of pixelated images and figures of merit computed based on the pixelated images by numerical electromagnetic simulation;
calculating a derivative of the one or more figures of merit with respect to pixel values of the pixelated image representing the topology; and
updating the pixelated image representing the topology based on the derivative.
